(19) United States
(12) Patent Application Publication
(10) Pub. No.: US 2024/0411433 A1
(43) Pub. Date: Dec. 12, 2024

(54) KNOWLEDGE CAPTURE ORCHESTRATION

(71) Applicant: Digital Intelligence Systems, LLC, McLean, VA (US)

(72) Inventors: Naveenkumar VIJAYAKUMAR, Plano, TX (US); Aravind KRISHNASWAMY, Plano, TX (US); Naman KHER, Phoenix, AZ (US)

(21) Appl. No.: 18/625,347

(22) Filed: Apr. 3, 2024

Related U.S. Application Data
(60) Provisional application No. 63/471,804, filed on Jun. 8, 2023.

(51) Int. Cl. G06F 3/0484; G06F 3/01; G06F 40/169

(52) U.S. Cl. CPC G06F 3/0484; G06F 3/013; G06F 40/169

(57) ABSTRACT

Methods, systems, and computer program products for implementing a knowledge capture process for a graphical user interface system. In response to receiving a knowledge capture request, a knowledge capture device provides a knowledge capture agent at a client device based on a knowledge capture protocol. The knowledge capture agent via a knowledge capture user interface orchestrates a screen capture session. Screen capture content including a plurality of frames for at least a portion of a user interface display is obtained for the screen capture session. User interaction data associated with the screen capture content is obtained for the screen capture session. Knowledge capture data is determined based on the screen capture content and the user interaction data. The knowledge capture data may be provided for display via the knowledge capture user interface at the client device.

### CROSS-REFERENCE TO RELATED APPLICATIONS

This application claims priority to U.S. Provisional Application No. 63/471,804, filed Jun. 8, 2023, which is incorporated herein by reference in its entirety.

### TECHNICAL FIELD

The present disclosure generally relates to computers and computer software, and more specifically, to methods, systems, and computer program products for implementing a knowledge capture process for graphical user interface-based application.

### BACKGROUND

The process of learning the current procedures and practices followed while taking over an existing project from another person, group, entity, service provider, and the like, is called “Knowledge Transfer” or “Project Transition”. Project onboarding and transition includes discovery of current information and processes followed by clients or incumbents. For several different types of businesses, it is very important to capture internal knowledge and business practices to be successful.

Business Process Modeling Notation (BPMN) is an example of a flow chart method that models the steps of a planned business process from end-to-end. A key to Business Process Management, a BPMN visually depicts a detailed sequence of business activities and information flows needed to complete a process. At a high level, BPMN, or other knowledge capture models, may be targeted at participants and other stakeholders in a business process to gain understanding through an easy-to-understand visual representation of the steps. At a more involved level, BPMN may be targeted at the people who will implement the process, giving sufficient detail to enable precise implementation. It provides a standard, common language for all stakeholders, whether technical or non-technical: business analysts, process participants, managers and technical developers, as well as external teams and consultants. Ideally, BPMN may bridge the gap between process intention and implementation by providing sufficient detail and clarity into the sequence of business activities. The diagramming can be far easier to understand than narrative text would be. It allows for easier communication and collaboration to reach the goal of an efficient process that produces a high-quality result. It also helps with communication to documents that may need to execute various processes (e.g., Extensible Markup Language (XML) documents, or the like).

There is a need for several business entities for more efficient means for automatically creating knowledge capture events and generating BPMN documentation. While there are different software systems that provide screen capture and annotation tools, there is a need for more user-friendly and more efficient workflows for end users to create documents for knowledge capture events.

### SUMMARY

In embodiments of the invention, a method for implementing a knowledge capture process. The method includes, at a knowledge capture device including one or more processors, in response to receiving a knowledge capture request, providing a knowledge capture agent at a client device based on a knowledge capture protocol, orchestrating, by the knowledge capture agent via a knowledge capture user interface at the client device, a screen capture session, obtaining screen capture content including a plurality of frames for at least a portion of a user interface display for the screen capture session, obtaining user interaction data associated with the screen capture content for the screen capture session, determining knowledge capture data based on the screen capture content and the user interaction data, and providing, for display via the knowledge capture user interface at the client device, the knowledge capture data.

These and other embodiments can each optionally include one or more of the following features.

In some embodiments of the invention, obtaining user interaction data associated with the screen capture content for the screen capture session includes obtaining at least one of screen click data, keyboard entry data, input device data, metadata associated with user interface elements, and gaze information. In some embodiments of the invention, determining the knowledge capture data based on the screen capture content and the user interaction data includes selecting screenshots of the plurality of frames of the obtained screen capture content.

In some embodiments of the invention, determining the knowledge capture data further includes removing one or more screenshots based on the user interaction data. In some embodiments of the invention, determining the knowledge capture data further includes determining a subset of the one or more of the selected screenshots for annotations, and providing an annotation tool for annotating at least a portion of each screenshot of the subset of the one or more of the selected screenshots. In some embodiments of the invention, the knowledge capture data includes annotations to the one or more of the selected screenshots.

In some embodiments of the invention, orchestrating a screen capture session by the knowledge capture agent is initiated based on detecting a trigger event. In some embodiments of the invention, the trigger event is based on based on a user interactivity. In some embodiments of the invention, the trigger event is based on detecting a user interface event. In some embodiments of the invention, the trigger event is based on detecting a change of data associated with a user interface element. In some embodiments of the invention, the trigger event is based on gaze information of a user.

In some embodiments of the invention, providing the knowledge capture data includes providing at least one of a document, video, or a Business Process Modeling Notation (BPMN) chart.

In some embodiments of the invention, providing the knowledge capture agent at the client device includes determining that the knowledge capture agent is not installed at the client device, and pushing an installation element to the client device for installation of the knowledge capture agent.

In some embodiments of the invention, the method further includes the actions of storing the knowledge capture data in a knowledge repository database.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an example environment for implementing a knowledge capture process, according to embodiments of the invention.

FIG. 2 illustrates an example knowledge capture process based on a knowledge capture request, according to embodiments of the invention.

FIG. 3 illustrates an example knowledge capture process, according to embodiments of the invention.

FIGS. 4A and 4B illustrate a series of example screenshots for a knowledge capture process, according to embodiments of the invention.

FIGS. 5A and 5B illustrate example screenshots for adding annotations during a knowledge capture process, according to embodiments of the invention.

FIG. 6 illustrates an example Business Process Modeling Notation (BPMN) chart as part of a knowledge capture process, according to embodiments of the invention.

FIG. 7 is a flowchart of an example process for a user login for a knowledge capture process, according to embodiments of the invention.

FIG. 8 is a flowchart of an example process for user authentication for a knowledge capture process, according to embodiments of the invention.

FIG. 9 is a flowchart of an example process for implementing a knowledge capture process, according to embodiments of the invention.

FIG. 10 is a flowchart of an example process for data processing for a knowledge capture process, according to embodiments of the invention.

FIG. 11 is a flowchart of an example process for data review for a knowledge capture process, according to embodiments of the invention.

FIG. 12 is a flowchart of an example process for implementing a knowledge capture process, according to embodiments of the invention.

FIG. 13 is a block diagram showing an example computer architecture for a computer capable of executing the software components described herein, according to embodiments described herein.

### DETAILED DESCRIPTION

The technology in this patent application is related to systems and methods for implementing a knowledge capture process (e.g., a knowledge capture service) utilizing one or more knowledge capture servers that are in communication with one or more host/source systems. The knowledge capture process is provided for automatically capturing application screens of a user interface for knowledge capture and documentation during project onboarding and transition. The knowledge capture tools described herein may include creating a screen capture and automatically annotating a portion of the image of the user interface to display associated application elements or providing guidance to a user on potential areas for annotations. The user may be able to edit and rearrange the image order before the recording can be saved as a video, a portable document format (PDF) document, or another digital file format. Additionally, knowledge capture tools may provide automatic generation of a BPMN representation of the recorded business process.

More specifically, this technology includes a process that, at a knowledge capture device that includes one or more processors, in response to receiving a knowledge capture request (e.g., user loads the process page and clicks on a recording button, or automatically started), providing a knowledge capture agent at a client device based on a knowledge capture protocol. The process may further include orchestrating, by the knowledge capture agent via a knowledge capture user interface (e.g., a front-end API-“knowledge capture page”, browser based or client plugin agent) at the client device, a screen capture session (e.g., based on the user start/stopping session, based on a trigger event such as voice or gaze information, or the like). The process may further include obtaining screen capture content including a plurality of frames (e.g., images and/or video) for at least a portion of a user interface display for the screen capture session (e.g., could be for one window or for the entire displayed screen). The process may further include obtaining user interaction data associated with the screen capture content for the screen capture session. For example, obtaining user interaction data may include obtaining some or all screen clicks and keyboard entries, hover data, metadata (e.g., what is being clicked, right or left click, double clicked, html/webpage info, etc.), and gaze information or other physiological signals.

The process may further include determining knowledge capture data based on the screen capture content and the user interaction data. For example, the knowledge capture system may recommend and/or generate PDFs based on screen strokes/clicks. Additionally, the knowledge capture system may recommend an end user to annotate different features, determine which frames to capture and/or store based on user interactivity (e.g., per click or hover action) and/or a change of data (e.g., an online purchase, a content item such as a gif start/stop, based on gaze information, or the like).

The process may further include providing, for display via the knowledge capture user interface (e.g., a front end API) at the client device (e.g., to the client via a host system knowledge capture agent), the knowledge capture data (e.g., display capture results on the knowledge capture user interface page, display the captured images/user annotations, etc.), provide user options to download different digital files (e.g., video, annotated PDFs, BPMN flowcharts, etc.), and provide recommendations to encourage end user to add annotations.

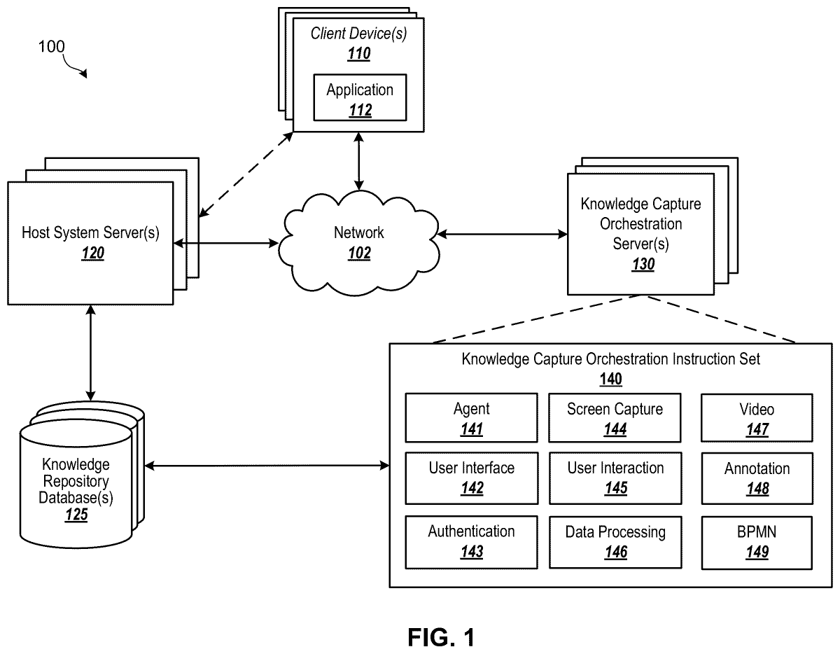

FIG. 1 is an example operating environment 100 of a distributed database environment for implementing a knowledge capture process, according to embodiments of the invention. The example operating environment 100 includes one or more client device(s) 110, one or more host system server(s) 120, and one or more knowledge capture orchestration server(s) 130, that communicate over a data communication network 102, e.g., a local area network (LAN), a wide area network (WAN), the Internet, a mobile network, or a combination thereof.

The one or more client device(s) 110 (e.g., a device used by an end user or client) can include a desktop, a laptop, a server, or a mobile device, such as a smartphone, tablet computer, wearable device (e.g., smartwatch), in-car computing device, and/or other types of mobile devices. Additionally, the one or more client device(s) 110 may be public uses devices such as a kiosk, a user terminal, and the like. The one or more client device(s) 110 includes applications, such as the application 112 (e.g., a knowledge capture agent), for managing a knowledge capture process to/from the one or more host system server(s) 120. The one or more client device(s) 110 can include other applications. The one or more client device(s) 110 may initiate a knowledge capture request by a user via application 112. The knowledge capture agent (e.g., via application 112) may provide a user for automatically capturing application screens of a user interface for knowledge capture and documentation during project onboarding and transition. The user interface tool may include creating a screen capture and annotating a portion of an image of the user interface to display associated application elements. The user may be able to edit and rearrange the image order of the knowledge capture process via the user interface before the recording can be saved as a video or PDF document, and auto generating a BPMN representation of the business process (if desired and/or applicable to the knowledge being captures for the particular knowledge capture request).

The one or more host system server(s) 120 manages knowledge capture events received from application 112 from the one or more client devices 110. The one or more host system server(s) 120 may be a personal computing device, tablet computer, thin client terminal, smart phone and/or other such computing device. The one or more host system server(s) 120 may be front-end server(s) for managing, collecting, processing, and communicating data, information, and records (e.g., requests, resource information, management data, bookings data, system configurations data, etc.), that is stored in the knowledge repository database 125. Further, the one or more host system server(s) 120 may be front-end server(s) for managing, collecting, processing, and communicating knowledge capture requests and knowledge capture orchestration data from one or more knowledge capture orchestration server(s) 130 to the client device(s) 110. The one or more host system server(s) 120 may receive knowledge capture request data from a client device 110 to initiate a knowledge capture process as further described herein.

The one or more knowledge capture orchestration server(s) 130 receives and processes the knowledge capture request(s) from a host system server 120. The one or more knowledge capture orchestration server(s) 130 includes a knowledge capture orchestration instruction set 140 that performs a knowledge capture protocol according to processes described herein. The knowledge capture orchestration instruction set 140 may include a plurality of service modules (also referred to herein as “knowledge capture orchestration submodules” or “micro-services”).

The knowledge capture orchestration instruction set 140 may include a knowledge capture agent module 141 that determines whether the client device 110 has a knowledge capture agent installed (e.g., application 112), and if not, initiates a download process to install the knowledge capture agent. The knowledge capture orchestration instruction set 140 may include a user interface module 142 for generating and managing a knowledge capture user interface (e.g., a front-end API such as a “knowledge capture page”). Additionally, or alternatively, the knowledge capture user interface via application 112 may include a free-floating widget application window providing the one or more knowledge capture tools overlaying a user interface at the client device 110. The knowledge capture orchestration instruction set 140 may include an authentication module 143 to verify a user (e.g., decrypt user login information and validate via a validation database). The knowledge capture orchestration instruction set 140 may include a screen capture module 144 that is configured to obtain screen capture content that includes several frames (e.g., images and/or video) for at least a portion of a user interface display for the screen capture session (e.g., could be for one window, one screen of a multiple screen setup, or the entire displayed system). The knowledge capture orchestration instruction set 140 may include a user interaction module 145 that is configured to obtain user interaction data such as all screen clicks and keyboard entries, hover data, metadata (e.g., what is being clicked, right or left click, double clicked, html/webpage info, etc.), or physiological information of the user (e.g., eye gaze information) associated with the screen capture content for the screen capture session. The knowledge capture orchestration instruction set 140 may include a data processing module 146 that is configured to control how the images are uploaded and processed. The knowledge capture orchestration instruction set 140 may include a video module 147 that is configured to generate a video of the knowledge capture process. The knowledge capture orchestration instruction set 140 may include an annotation module 148 that is configured to allow the user to edit, annotate, mask the images, and add any description to tag with the image(s). The knowledge capture orchestration instruction set 140 may include a BPMN module 149 that is configured to generate one or more BPMN charts based on the selected images for the knowledge capture process.

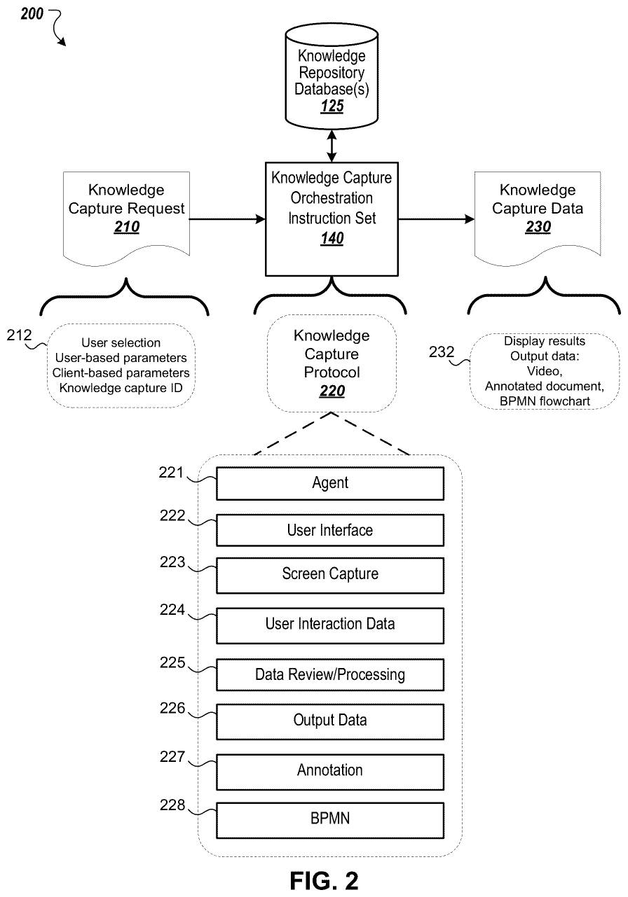

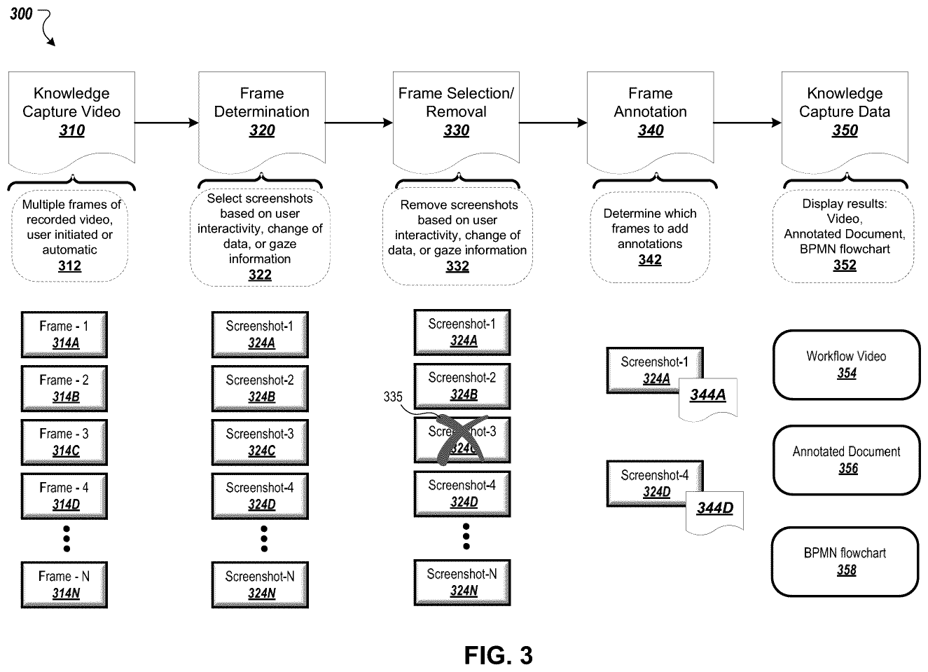

An example routine of implementing a knowledge capture protocol as illustrated in the environment of FIG. 1 is further discussed herein with reference to the example environments of FIGS. 2 and 3.

FIG. 2 illustrates an example knowledge capture process based on a knowledge capture request, according to embodiments of the invention. In particular, FIG. 2 illustrates an example environment 200 for a knowledge capture orchestration implementation for determining knowledge capture data 230 based on receiving a knowledge capture request 210. The objective for the knowledge capture orchestration instruction set 140 is to implement a knowledge capture process (e.g., a knowledge capture service that includes a complex orchestration aspect on front-end side to be able to call the knowledge capture services in the right order and at the right time of the knowledge capture flow) utilizing one or more knowledge capture orchestration servers that are in communication with the host system servers 120 and client devices 110. For example, the knowledge capture orchestration instruction set 140, stored on one or more knowledge capture orchestration server(s) 130, receives a knowledge capture request 210 (e.g., from a client device 110). The knowledge capture request 210 includes knowledge capture request information 212 that may be based on user selection criteria to start the knowledge capture, or automatically initiated based on user-based parameters or client-based parameters (e.g., settings from the entity/owner of the client devices, etc.) that is associated with a knowledge capture session. In some implementations, the knowledge capture request information 212 may include a knowledge capture record ID for the knowledge capture session (e.g., a user-based ID, an IP address associated with the client device 110 that initiated the knowledge capture request 210, a time stamp associated with the start or duration of the knowledge capture request 210, a combination thereof, or the like). In some implementations, the complete set of knowledge capture data 230 is not in the request query (e.g., knowledge capture request information 212), however, a knowledge capture record ID may allow the knowledge capture orchestration instruction set 140 to identify the knowledge capture session data in the knowledge repository database 125 to retrieve all the related knowledge capture data.

The knowledge capture orchestration instruction set 140 initiates a knowledge capture protocol 220 to generate knowledge capture data 230. The knowledge capture protocol 220 includes, for example, one or more modules to perform a plurality of features/services. For example, the agent module 221 determines whether the client device 110 has a knowledge capture agent installed (e.g., application 112), and if not, initiates a download process to install the knowledge capture agent. The user interface module 222 generates and manages a knowledge capture user interface (e.g., a front-end API such as a “knowledge capture page”). The authentication module 143 verifies a user (e.g., decrypt user login information and validate via a validation database). The screen capture module 223 obtains screen capture content that includes several frames (e.g., images and/or video) for at least a portion of a user interface display for the screen capture session (e.g., could be for one window, one screen of a multiple screen setup, or the entire displayed system). The user interaction module 224 obtains user interaction data such as all screen clicks and keyboard entries, hover data, metadata (e.g., what is being clicked, right or left click, double clicked, html/webpage info, etc.), and/or physiological information of the user (e.g., eye gaze information) associated with the screen capture content for the screen capture session. The data review/processing module 225 controls the uploading and processing of the selected images from the knowledge capture session. The output data module 226 generates a video of the knowledge capture process. The annotation module 227 allows the user to edit, annotate, mask the images, and add any description to tag with the image(s), and may automatically provide suggested annotations (e.g., based on the user interaction data). The BPMN module 228 generates one or more BPMN charts based on the selected images for the knowledge capture process.

The knowledge capture data 230 may include knowledge capture orchestration results data 232 such as display results, and output data such as video, annotated documents (PDF file), a BPMN flowchart, a combination thereof, or the like. An example illustration of implementing a knowledge capture protocol as illustrated in FIG. 2 is further discussed herein with reference to FIG. 3.

FIG. 3 illustrates an example knowledge capture process, according to embodiments of the invention. In particular, FIG. 3 illustrates an example environment 300 for a knowledge capture orchestration implementation for determining knowledge capture data 350 from a knowledge capture video block 310. The knowledge capture video block 310 may include knowledge capture data 312, which may include multiple frames of recorded video that was user initiated or based on parameter settings that automatically initiated the recording. The multiple frames of recorded video knowledge capture data 312 are illustrated as frame-1 314A, frame-2 314B, frame-3 314C, frame-4 314D through frame-N 314N for exemplary illustration purposes. Then, at the frame determination block 320, selected screenshot data 322 may be determined. In some embodiments, the selected screenshot data 322 is based on user interactivity, change of data, physiological information of the user (e.g., gaze information), a combination thereof, or the like. The multiple screenshots of selected screenshot data 322 are illustrated as screenshot-1 324A, screenshot-2 324B, screenshot-3 324C, screenshot-4 324D through frame-N 324N that correlate to the collected frames 314 for exemplary illustration purposes.

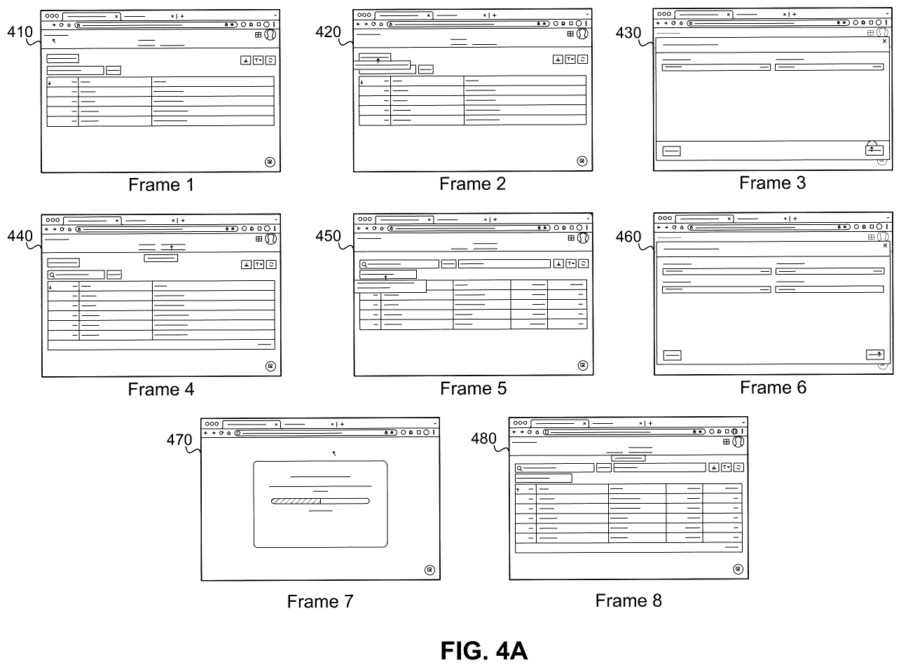

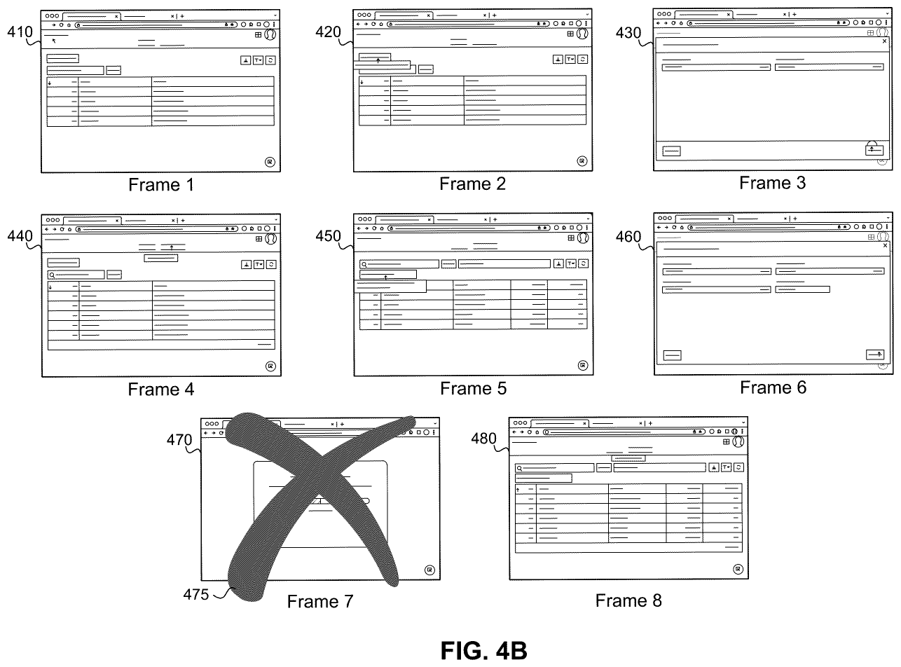

At the frame selection removal block 330, selective screenshot data 332 may be determined. In some embodiments, the selective screenshot data 332 includes removing particular screenshots 324 based on the determined user interactivity, change of data, physiological information of the user (e.g., gaze information), or the like. For example, as illustrated by mark 335, screenshot-3 324C is removed. Removing one or more screenshots is further illustrated in FIGS. 4A and 4B.

FIGS. 4A and 4B illustrate example screenshots for a knowledge capture process, according to embodiments of the invention. In particular, FIG. 4A illustrates the collected screenshots during a knowledge capture process of a user (e.g., a business process for adding a new client matter number into a company system). For example, a user initiates a knowledge capture recording session (e.g., clicks a start recording button), and video frames are captured: Frame-1 410, Frame-2 420, Frame-3 430, Frame-4 440, Frame-5 450, Frame-6 460, Frame-7 470, and Frame-8 480. FIG. 4B illustrates removing particular frames (screenshots) based on the determined user interactivity (e.g., clicks or hover data), change of data (e.g., different windows are activated), physiological information of the user (e.g., gaze information), or the like. For example, as illustrated by mark 475, the process described herein determines to remove the screenshot Frame-7 470. For example, screenshot Frame-7 470 may be a brief “loading” screen that popped up during the capture session, or a similar screenshot that is not relevant to the knowledge capture process intended for the knowledge capture recording.

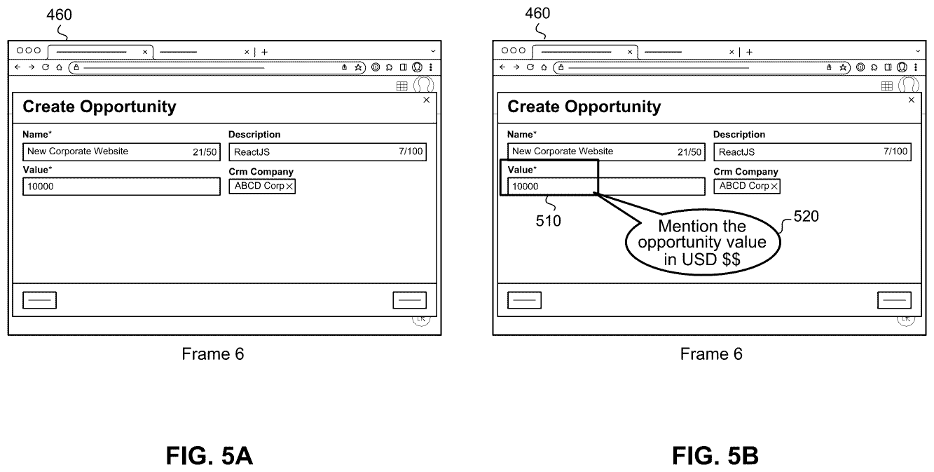

Returning to FIG. 3, at the frame annotation block 340, annotation data 342 may be determined. In some embodiments, the frame annotation block 340 determines which frames to add annotations for the annotation data 342. For example, an annotation module may allow the user to edit, annotate, mask the images, and add any description to tag with the image(s), and may automatically provide suggested annotations (e.g., based on the user interaction data). As illustrated in FIG. 3, annotation 344A is added to the screenshot-1 324A, and annotation 344D is added to the screenshot-4 324D. Annotating one or more screenshots is further illustrated in FIGS. 5A and 5B.

FIGS. 5A and 5B illustrate example screenshots for adding annotations during a knowledge capture process, according to embodiments of the invention. In particular, FIG. 5A illustrates a closer view of the screenshot Frame-6 460 from FIG. 4. Then, after the annotation module analyzes the image, the knowledge capture processes described herein may determine that a particular portion of the screenshot Frame-6 460 may benefit from an annotation based on some determined activity of the user or from determined from previous knowledge capture sessions stored in the knowledge repository database 125. For example, a determined activity of the user may be some audio recorded and transcribed during the knowledge capture to highlight some sort of activity that has occurred, is occurring, or should occur for the particular screenshot. As illustrated in FIG. 5B, a particular portion of the screenshot Frame-6 460 as highlight by area 510 (e.g., a “Value*” entry box), the system determined to supplement the image of the screenshot Frame-6 460 with the annotation 520 (e.g., “Mention the opportunity value in USD $$”). As discussed herein, the annotation 520 may be based on user audio (e.g., voice transcription), or may be entered by the user during a review of the captured screenshot data.

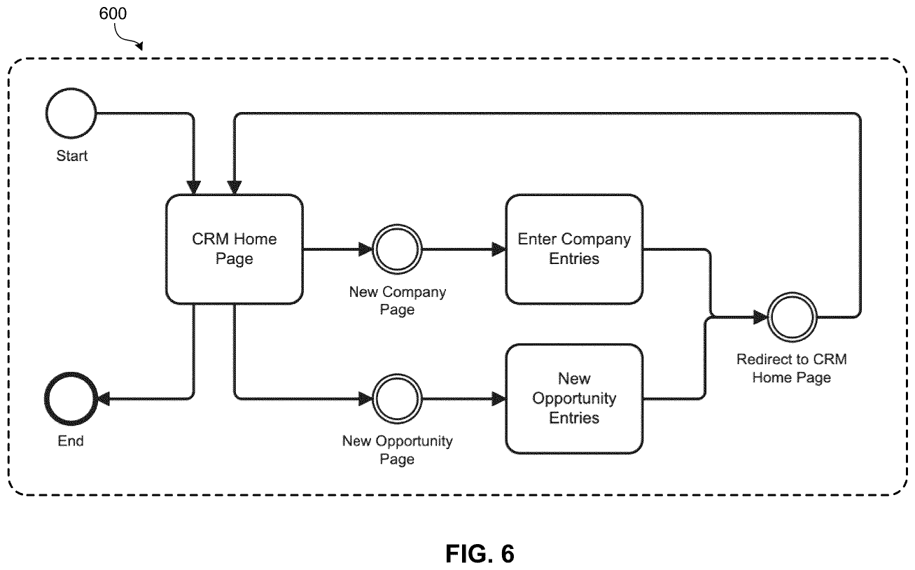

Returning to FIG. 3, at the knowledge capture data block 350, knowledge capture data 352 may be generated. In some embodiments, the knowledge capture data block 350 may generate one or more digital files. For example, the one or more digital files may include a workflow video 354, an annotated document 356 (e.g., a PDF document), and/or a BPMN flowchart 358. An example of a BPMN flowchart 358 for the knowledge capture process of FIG. 3 is illustrated in FIG. 6.

FIG. 6 illustrates an example Business Process Modeling Notation (BPMN) chart 600 as part of a knowledge capture process, according to embodiments of the invention. In particular, BPMN chart 600 illustrates an example steps of a planned business process from end-to-end for creating a new company and a new opportunity page. In some implementations, the knowledge capture tools described herein may provide an automatic generation of a BPMN representation of the recorded business process (e.g., BPMN chart 600).

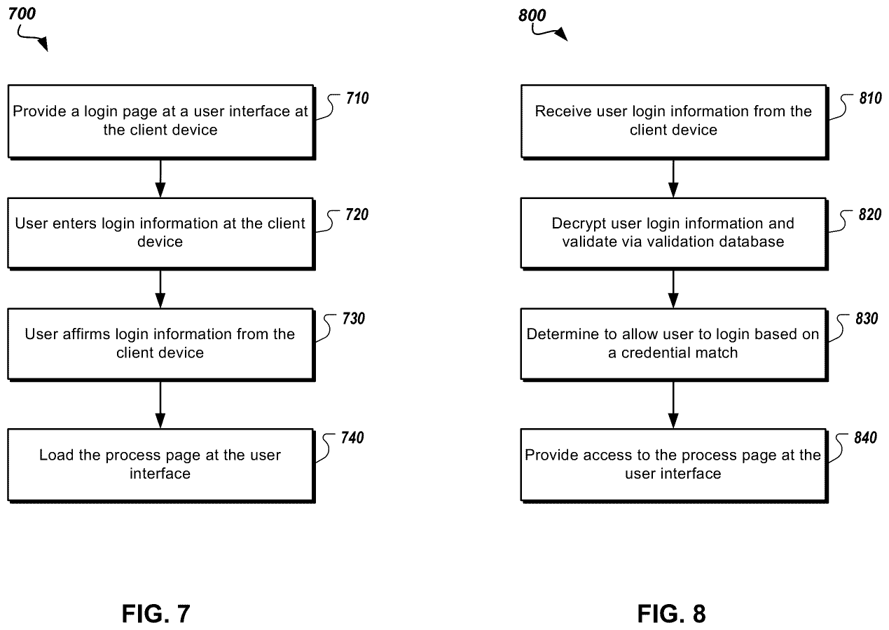

The actions of the knowledge capture orchestration server(s) 130 utilizing the knowledge capture orchestration instruction set 140 to process a knowledge capture protocol as described in FIGS. 1-6, are further described herein with reference to the method flowcharts of processes 700-1200 in FIGS. 7-12, respectively.

FIGS. 7-12 illustrate flowcharts of various example processes 700-1200 for orchestration of a knowledge capture process, according to embodiments of the invention. Operations of the processes 700-1200 can be implemented, for example, by a system that includes one or more data processing apparatus, such as one or more knowledge capture orchestration server(s) 130 of FIG. 1 utilizing a knowledge capture orchestration instruction set 140. The processes 700-1200 can also be implemented by instructions stored on computer-readable storage medium, where execution of the instructions by a system that includes a data processing apparatus cause the data processing apparatus to perform the operations of the processes 700-1200.

FIG. 7 is a flowchart of an example process 700 for a user login for a knowledge capture process, according to embodiments of the invention. In an exemplary implementation for the knowledge capture process 700, the system, at a knowledge capture device that includes one or more processors, provides a login page at a user interface at the client device (710), a user enters login information at the client device (720), a user affirms login information from the client device (730), and the system loads the process page at the user interface (740). Process 700 illustrates a workflow that is a diagrammatic representation user login workflow for the knowledge capture application. Process 700 provides an entry point for the user to communicate with the knowledge capture agent to initiate a screen capture session.

FIG. 8 is a flowchart of an example process 800 for user authentication for a knowledge capture process, according to embodiments of the invention. In an exemplary implementation for the knowledge capture process 800, the system, at a knowledge capture device that includes one or more processors, receives user login information from the client device (810), decrypts the user login information and validates via validation database (820), determines whether to allow the user to login based on a credential match (830), and provides access to the process page at the user interface (840). Process 800 illustrates a workflow that is a diagrammatic representation for a backend authentication workflow. Process 800 provides the knowledge capture application and may validate if a user is authorized to use the application (e.g., authentication module 143).

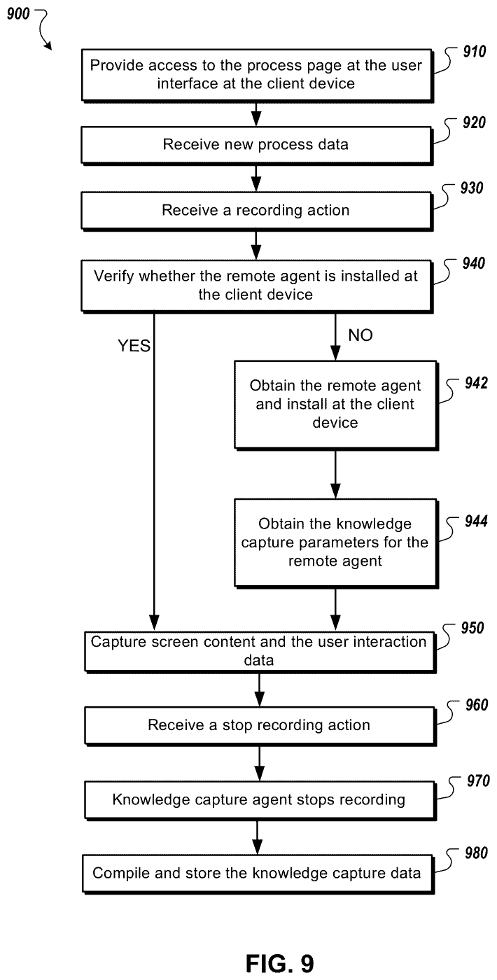

FIG. 9 is a flowchart of an example process 900 for implementing a knowledge capture process, according to embodiments of the invention. In an exemplary implementation for the knowledge capture process 900, the system, at a knowledge capture device that includes one or more processors, provides access to the process page at the user interface at the client device (910), receives new process data (920), receives a recording action (930) (e.g., user clicks on start recording button), and verifies whether the remote agent is installed at the client device (940). If the remote agent is not installed at the client device at block 840 (e.g., “NO”), then the system obtains the remote agent and install at the client device (942), obtains the knowledge capture parameters for the remote agent (944), and then captures screen content and the user interaction data (950). However, if the remote agent is installed at the client device at block 840 (e.g., “YES”), then the system can proceed directly to block 950 and capture screen content and the user interaction data. The system continues to capture screen content and user interaction data at block 950 until the system receives a stop recording action (960), and then the knowledge capture agent stops recording (970), and the system compiles and stores the knowledge capture data (980). Process 900 illustrates a workflow that is a diagrammatic representation for a knowledge capture workflow. Process 900 provides a screen capture session that may be initiated from the server to the knowledge capture agent. Process 900 may include a user-initiated session and a user may have full control to start and stop the session.

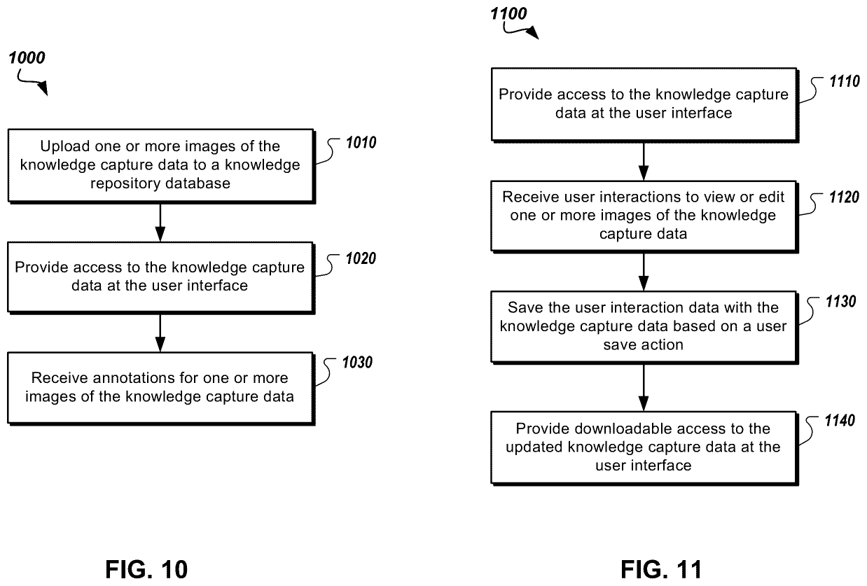

FIG. 10 is a flowchart of an example process 1000 for data processing for a knowledge capture process, according to embodiments of the invention. In an exemplary implementation for the knowledge capture process 1000, the system, at a knowledge capture device that includes one or more processors, uploads one or more images of the knowledge capture data to a knowledge repository database (1010), provides access to the knowledge capture data at the user interface (1020), and receives annotations for one or more images of the knowledge capture data (1030) (e.g., the user may review the images and write any relevant note that may be desired or recommended by the system as described herein). Process 1000 illustrates a workflow that is a diagrammatic representation for a data processing workflow. Process 1000 controls how the images are uploaded and processed and before allowing a final commit, the user may be allowed to edit, annotate, mask the images, and add any description to tag with the image (e.g., data processing module 146 and annotation module 148).

FIG. 11 is a flowchart of an example process 1100 for data review for a knowledge capture process, according to embodiments of the invention. In an exemplary implementation for the knowledge capture process 1100, the system, at a knowledge capture device that includes one or more processors, provides access to the knowledge capture data at the user interface (1110), receives user interactions to view or edit one or more images of the knowledge capture data (1120), saves the user interaction data with the knowledge capture data based on a user save action (1130), and provides downloadable access to the updated knowledge capture data at the user interface (1140) (e.g., after the information is saved, the output can be downloaded as a video, document, and/or a BPMN flowchart). Process 1100 illustrates a workflow that is a diagrammatic representation for a review and edit workflow. Process 1100, after the user saves or stops the knowledge capture process, provides the captured images along with the user edits and saves to the database (e.g., knowledge repository database 125). After the knowledge capture session data is saved in the database, the user can then download the knowledge capture session output in video, PDF, word, or the type of file formats.

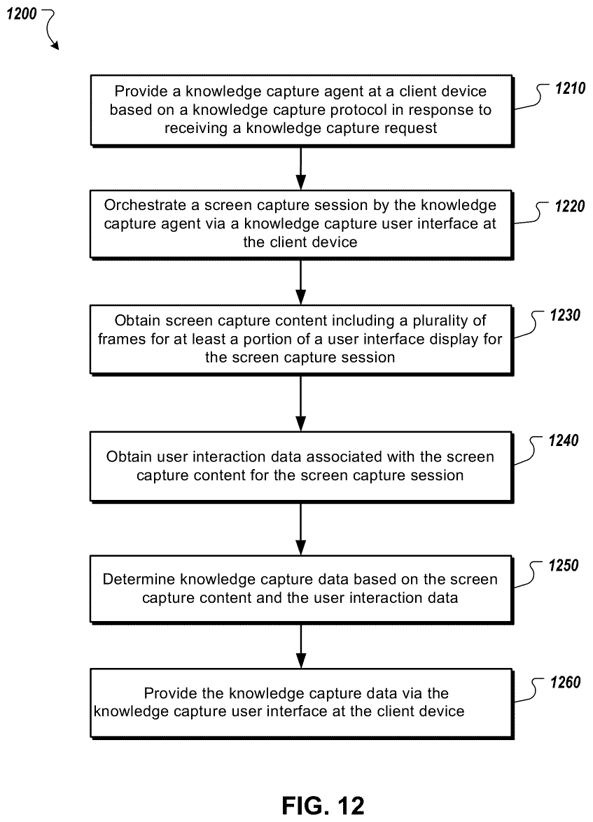

FIG. 12 is a flowchart of an example process 1200 for implementing a knowledge capture process and providing the knowledge capture data for display at a user interface, according to embodiments of the invention. In an exemplary implementation for the knowledge capture process 1200, the system, at a knowledge capture device that includes one or more processors, provides a knowledge capture agent at a client device based on a knowledge capture protocol in response to receiving a knowledge capture request (1210). In some implementations, the knowledge capture request is encoded with knowledge capture identification information, and the knowledge capture orchestration user interface provides access to a plurality of knowledge capture processor servers and a plurality of knowledge capture service modules (e.g., the submodules 141-149 of the knowledge capture orchestration instruction set 140 of FIG. 1). In some implementations, the knowledge capture request is received at a front-end API (e.g., a “knowledge capture page”) at a client device (e.g., a start recording feature). In some implementations, the knowledge capture request may include a knowledge capture record ID for the knowledge capture session (e.g., a user-based ID, an IP address associated with the client device 110 that initiated the knowledge capture request 210, a time stamp associated with the start or duration of the knowledge capture request 210, a combination thereof, or the like).

In some implementations, providing the knowledge capture agent at the client device includes determining that the knowledge capture agent is not installed at the client device, and pushing an installation element to the client device for installation of the knowledge capture agent.

The system orchestrates a screen capture session by the knowledge capture agent via a knowledge capture user interface at the client device (1220). For example, as illustrated in FIG. 2, the knowledge capture orchestration instruction set 140 initiates a knowledge capture protocol 220 to generate knowledge capture data 230. In some implementations, the knowledge capture protocol 220 includes, for example, one or more modules to perform a plurality of features/services. For example, the agent module 221 determines whether the client device 110 has a knowledge capture agent installed (e.g., application 112), and if not, initiates a download process to install the knowledge capture agent. The user interface module 222 generates and manages a knowledge capture user interface (e.g., a front-end API such as a “knowledge capture page”). The authentication module 143 verifies a user (e.g., decrypt user login information and validate via a validation database). The screen capture module 223 obtains screen capture content that includes several frames (e.g., images and/or video) for at least a portion of a user interface display for the screen capture session (e.g., could be for one window, one screen of a multiple screen setup, or the entire displayed system). The user interaction module 224 obtains user interaction data such as all screen clicks and keyboard entries, hover data, metadata (e.g., what is being clicked, right or left click, double clicked, html/webpage info, etc.), and/or physiological information of the user (e.g., eye gaze information) associated with the screen capture content for the screen capture session. The data review/processing module 225 controls the uploading and processing of the selected images from the knowledge capture session. The output data module 226 generates a video of the knowledge capture process. The annotation module 227 allows the user to edit, annotate, mask the images, and add any description to tag with the image(s), and may automatically provide suggested annotations (e.g., based on the user interaction data). The BPMN module 228 generates one or more BPMN charts based on the selected images for the knowledge capture process.

In some implementations, orchestrating a screen capture session by the knowledge capture agent is initiated based on detecting a trigger event. In some implementations, the trigger event is based on based on a user interactivity (e.g., per click or hover action). In some implementations, the trigger event is based on detecting a user interface event. For example, a trigger event detection may be based on a user making a selection on the user interface, such as an online purchase, creating a new account/company, or the like. In some implementations, the trigger event is based on detecting a change of data associated with a user interface element (e.g., such as a gif start/stop). In some implementations, the trigger event is based on gaze information of a user.

The system obtains screen capture content including a plurality of frames for at least a portion of a user interface display for the screen capture session (1230). For example, as illustrated in FIG. 3, the knowledge capture orchestration server 130 obtains multiple frames of recorded video knowledge capture data 312 (e.g., illustrated as frame-1 314A, frame-2 314B, frame-3 314C, frame-4 314D through frame-N 314N).

The system obtains user interaction data associated with the screen capture content for the screen capture session (1240). For example, the knowledge capture orchestration server 130 via the knowledge capture orchestration instruction set 140 may obtain user interaction data such as all screen clicks and keyboard entries, hover data, metadata (e.g., what is being clicked, right or left click, double clicked, html/webpage info, etc.), and/or physiological information of the user (e.g., eye gaze information) associated with the screen capture content for the screen capture session.

In some implementations, obtaining user interaction data associated with the screen capture content for the screen capture session includes obtaining at least one of screen click data, keyboard entry data, input device data (hover data), metadata associated with user interface elements (e.g., what is being clicked, right or left click, double clicked, html/webpage info, etc.), and gaze information.

The system determines knowledge capture data based on the screen capture content and the user interaction data (1250). For example, the knowledge capture orchestration server 130 via the knowledge capture orchestration instruction set 140 may recommend and/or generate PDFs based on screen strokes/clicks. Additionally, the knowledge capture system may recommend to an end user to annotate different features, determine which frames to capture and/or store based on user interactivity (e.g., per click or hover action) and/or a change of data (e.g., an online purchase, a content item such as a gif start/stop, based on gaze information, or the like).

In some implementations, determining the knowledge capture data based on the screen capture content and the user interaction data includes selecting screenshots of the plurality of frames of the obtained screen capture content. For example, the knowledge capture system may recommend and generate a consolidated document (e.g., a PDF document) based on screen strokes/clicks, and may recommend to the end user to annotate different features. Additionally, or alternatively, the system may determine which frames to capture/store based on a user interactivity. In some implementations, determining the knowledge capture data further includes removing one or more screenshots based on the user interaction data.

In some implementations, determining the knowledge capture data further includes determining a subset of the one or more of the selected screenshots for annotations, and providing an annotation tool for annotating at least a portion of each screenshot of the subset of the one or more of the selected screenshots. For example, the system may provide automatic recommendations to encourage end user to add annotations. In some implementations, the knowledge capture data includes annotations to the one or more of the selected screenshots (e.g., either entered by the user or added/recommended by the system).

The system provides the knowledge capture data via the knowledge capture user interface at the client device (1260). For example, the front-end API (e.g., “knowledge capture page”) at the client device receives and displays the knowledge capture digital options (e.g., video, annotated document, BPMN chart, etc.), and the user can than make a selection and proceed with downloading the selected knowledge capture digital file. In some implementations, the user interface displays automatic recommendations to encourage end user to add annotations.

In some implementations, the process 1200 further includes storing the knowledge capture data in a knowledge repository database (e.g., knowledge repository database 125). In some implementations, the knowledge capture data is stored in the knowledge repository database 125 automatically and in a 1:1 ratio as the knowledge capture data was created. In some implementations, after detecting more than one knowledge capture session of the same or even a different knowledge capture process, the system can automatically, or based on user input, provide the ability to combine the different sessions as one knowledge capture session and output digital file.

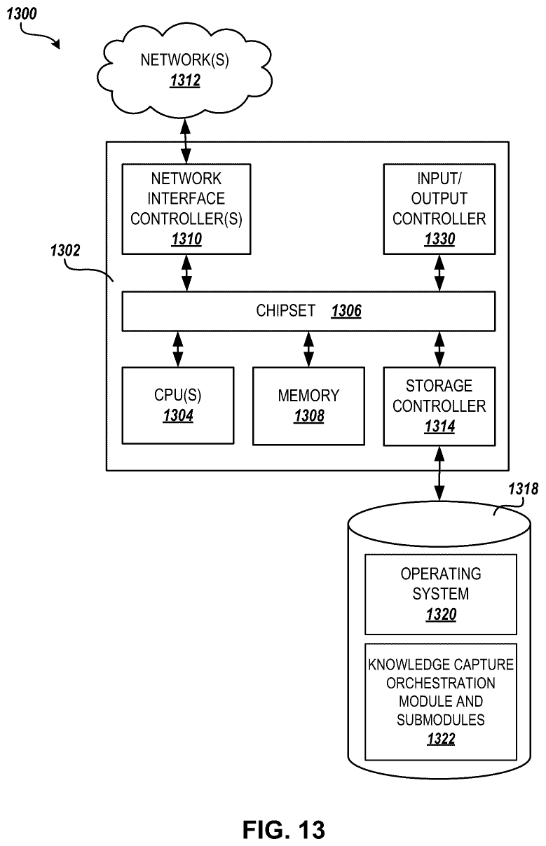

FIG. 13 illustrates an example computer architecture 1300 for a computer 1302 capable of executing the software components described herein for the sending/receiving and processing of tasks. The computer architecture 1300 (also referred to herein as a “server”) shown in FIG. 13 illustrates a server computer, workstation, desktop computer, laptop, a server operating in a cloud environment, or other computing device, and may be utilized to execute any aspects of the software components presented herein described as executing on a host server, or other computing platform. The computer 1302 preferably includes a baseboard, or “motherboard,” which is a printed circuit board to which a multitude of components or devices may be connected by way of a system bus or other electrical communication paths. In one illustrative embodiment, one or more central processing units (CPUs) 1304 operate in conjunction with a chipset 1306. The CPUs 1304 can be programmable processors that perform arithmetic and logical operations necessary for the operation of the computer 1302.

The CPUs 1304 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 1306 provides an interface between the CPUs 1304 and the remainder of the components and devices on the baseboard. The chipset 1306 may provide an interface to a memory 1308. The memory 1308 may include a random-access memory (RAM) used as the main memory in the computer 1302. The memory 1308 may further include a computer-readable storage medium such as a read-only memory (ROM) or non-volatile RAM (NVRAM) for storing basic routines that that help to startup the computer 1302 and to transfer information between the various components and devices. The ROM or NVRAM may also store other software components necessary for the operation of the computer 1302 in accordance with the embodiments described herein.

According to various embodiments, the computer 1302 may operate in a networked environment using logical connections to remote computing devices through one or more networks 1312, a local-area network (LAN), a wide-area network (WAN), the Internet, or any other networking topology known in the art that connects the computer 1302 to the devices and other remote computers. The chipset 1306 includes functionality for providing network connectivity through one or more network interface controllers (NICs) 1310, such as a gigabit Ethernet adapter. For example, the NIC 1310 may be capable of connecting the computer 1302 to other computer devices in the utility provider's systems. It should be appreciated that any number of NICs 1310 may be present in the computer 1302, connecting the computer to other types of networks and remote computer systems beyond those described herein.

The computer 1302 may be connected to at least one mass storage device 1318 that provides non-volatile storage for the computer 1302. The mass storage device 1318 may store system programs, application programs, other program modules, and data, which are described in greater detail herein. The mass storage device 1318 may be connected to the computer 1302 through a storage controller 1314 connected to the chipset 1306. The mass storage device 1318 may consist of one or more physical storage units. The storage controller 1314 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 1302 may store data on the mass storage device 1318 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 1318 is characterized as primary or secondary storage, or the like. For example, the computer 1302 may store information to the mass storage device 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1302 may further read information from the mass storage device 1318 by detecting the physical states or characteristics of one or more particular locations within the physical storage units.

The mass storage device 1318 may store an operating system 1320 utilized to control the operation of the computer 1302. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 1318 may store other system or application programs and data utilized by the computer 1302, such as the knowledge capture orchestration module and submodules 1322, which may include the knowledge capture orchestration instruction set 140 and the one or more submodules included therein, according to embodiments described herein. For example, the knowledge capture orchestration module and submodules 1322 may include submodules such as the knowledge capture agent module 141, the user interface module 142, the authentication module 143, the screen capture module 144, the user interaction module 145, the data processing module 146, the video module 147, the annotation module 148, the BPMN module 149, and/or other modules discussed herein or may otherwise be appropriate. Other system or application programs and data utilized by the computer 1302 may be provided as well (e.g., a security module, a fraud module, a validation module, etc.).

In some embodiments, the mass storage device 1318 may be encoded with computer-executable instructions that, when loaded into the computer 1302, transforms the computer 1302 from being a general-purpose computing system into a special-purpose computer capable of implementing the embodiments described herein. These computer-executable instructions transform the computer 1302 by specifying how the CPUs 1304 transition between states, as described above. According to some embodiments, from the knowledge capture orchestration server(s) 130 perspective, the mass storage device 1318 stores computer-executable instructions that, when executed by the computer 1302, perform portions of the process 500, for implementing a knowledge capture orchestration system, as described herein. In further embodiments, the computer 1302 may have access to other computer-readable storage medium in addition to or as an alternative to the mass storage device 1318.

The computer 1302 may also include an input/output controller 1330 for receiving and processing input from a number of input devices, such as a keyboard, a mouse, a touchpad, a touch screen, an electronic stylus, or other type of input device. Similarly, the input/output controller 1330 may provide output to a display device, such as a computer monitor, a flat-panel display, a digital projector, a printer, a plotter, or other type of output device. It will be appreciated that the computer 1302 may not include all of the components shown in FIG. 13, may include other components that are not explicitly shown in FIG. 13, or may utilize an architecture completely different than that shown in FIG. 13.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method comprising:
at a knowledge capture device comprising one or more processors:
in response to receiving a knowledge capture request, providing a knowledge capture agent at a client device based on a knowledge capture protocol;
orchestrating, by the knowledge capture agent via a knowledge capture user interface at the client device, a screen capture session;
obtaining screen capture content comprising a plurality of frames for at least a portion of a user interface display for the screen capture session;
obtaining user interaction data associated with the screen capture content for the screen capture session;
determining knowledge capture data based on the screen capture content and the user interaction data; and
providing, for display via the knowledge capture user interface at the client device, the knowledge capture data.

2. The method of claim 1, wherein obtaining user interaction data associated with the screen capture content for the screen capture session comprises obtaining screen click data, keyboard entry data, input device data, metadata associated with user interface elements, gaze information, or a combination thereof.

3. The method of claim 1, wherein determining the knowledge capture data based on the screen capture content and the user interaction data comprises:
selecting screenshots of the plurality of frames of the obtained screen capture content.

4. The method of claim 1, wherein determining the knowledge capture data further comprises:
removing one or more screenshots based on the user interaction data.

5. The method of claim 3, wherein determining the knowledge capture data further comprises:
determining a subset of the one or more of the selected screenshots for annotations; and
providing an annotation tool for annotating at least a portion of each screenshot of the subset of the one or more of the selected screenshots.

6. The method of claim 3, wherein the knowledge capture data comprises annotations to the one or more of the selected screenshots.

7. The method of claim 1, wherein orchestrating the screen capture session by the knowledge capture agent comprises:
detecting a trigger event; and
in response to the trigger event, initiating the screen capture session.

8. The method of claim 7, wherein the trigger event is based on based on a user interactivity.

9. The method of claim 7, wherein the trigger event is based on detecting a user interface event.

10. The method of claim 7, wherein the trigger event is based on detecting a change of data associated with a user interface element.

11. The method of claim 7 wherein the trigger event is based on gaze information of a user.

12. The method of claim 1, wherein the knowledge capture data comprises a document, video, a Business Process Modeling Notation (BPMN) chart, or a combination thereof.

13. The method of claim 1, wherein providing the knowledge capture agent at the client device comprises:
determining that the knowledge capture agent is not installed at the client device; and
pushing an installation element to the client device for installation of the knowledge capture agent.

14. The method of claim 1, further comprising:
storing the knowledge capture data in a knowledge repository database.

15. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
in response to receiving a knowledge capture request, providing a knowledge capture agent at a client device based on a knowledge capture protocol;
orchestrating, by the knowledge capture agent via a knowledge capture user interface at the client device, a screen capture session;
obtaining screen capture content comprising a plurality of frames for at least a portion of a user interface display for the screen capture session;
obtaining user interaction data associated with the screen capture content for the screen capture session;
determining knowledge capture data based on the screen capture content and the user interaction data; and
providing, for display via the knowledge capture user interface at the client device, the knowledge capture data.

16. The device of claim 15, wherein obtaining user interaction data associated with the screen capture content for the screen capture session comprises obtaining screen click data, keyboard entry data, input device data, metadata associated with user interface elements, gaze information, or a combination thereof.

17. The device of claim 15, wherein determining the knowledge capture data based on the screen capture content and the user interaction data comprises:
selecting screenshots of the plurality of frames of the obtained screen capture content.

18. The device of claim 15, wherein determining the knowledge capture data further comprises:
removing one or more screenshots based on the user interaction data.

19. The device of claim 17, wherein determining the knowledge capture data further comprises:
determining a subset of the one or more of the selected screenshots for annotations; and
providing an annotation tool for annotating at least a portion of each screenshot of the subset of the one or more of the selected screenshots.

20. A non-transitory computer-readable storage medium, storing program instructions executable on a device to perform operations comprising:
in response to receiving a knowledge capture request, providing a knowledge capture agent at a client device based on a knowledge capture protocol;
orchestrating, by the knowledge capture agent via a knowledge capture user interface at the client device, a screen capture session;
obtaining screen capture content comprising a plurality of frames for at least a portion of a user interface display for the screen capture session;
obtaining user interaction data associated with the screen capture content for the screen capture session;
determining knowledge capture data based on the screen capture content and the user interaction data; and
providing, for display via the knowledge capture user interface at the client device, the knowledge capture data.
